(19) United States
(12) Patent Application Publication
(10) Pub. No.: US 2002/0043816 A1
(43) Pub. Date: Apr. 18, 2002

(54) Method and apparatus for covering and securing cargo on flatbed trailers

(76) Inventor: J. Ben Johnston, Monroeville, AL (US)

Correspondence Address: Duane Morris, LLP, 1667 K Street, NW, Suite 700, Washington, DC, 20006, US

(21) Appl. No.: 09/953,278

(22) Filed: Sep. 17, 2001

(51) Int. Cl. B60P 7/00

(52) U.S. Cl. 296/98

(57) ABSTRACT

Trailer mounted and terminal installation embodiments of an apparatus by which a single operator may easily and safely cover or uncover cargo loaded on a flatbed trailer before or during transit or after it has arrived at its destination, without materially interfering with the loading of the cargo from either side or the rear of the trailer, or from above. A single fixed installation may be used for plural flatbeds or the apparatus may itself be trailer mounted and sequentially positioned with respect to a plurality of parked flatbeds.

### RELATED APPLICATIONS

This application is a continuation-in-part application of pending U.S. patent application Ser. No. 09/622,320 for a Covering System for a Trailer and Method, filed Sep. 14, 2000.

### BACKGROUND OF THE INVENTION

The present invention relates to a system and method for covering and uncovering flatbed trailers and their associated cargo and for positioning straps or tie-downs for the cargo. It finds its greatest utility in the side to side covering and uncovering of cargo loaded on a flatbed trailer.

As described in detail in the application referenced above, the disclosure of which is hereby incorporated herein by reference, open flatbed trailers are widely used to transport various types of bulk freight and cargo. The protection of cargo from adverse weather and road conditions during transport is a major concern to the transportation industry. The process of covering and uncovering cargo and equipment loaded onto a flatbed trailer with a tarp or other type of cover is often difficult, and is particularly problematic during transit, after dark or in bad weather.

Conditions of high winds, limited visibility, precipitation and limited personnel can make it extremely difficult or hazardous to cover and uncover cargo, and serious injury may result, while in transit as well as in the course of loading and unloading cargo at work sites and terminals.

Several embodiments of a novel method and apparatus for the covering and uncovering of cargo on flatbed trailers are described in the above referenced application. This application is directed to still other embodiments, specifically embodiments which may be permanently installed at terminals, carried by a trailer, or mounted on an individual flat bed trailer, and which do not interfere with the loading and unloading of the cargo from the top, side or end of the flatbed trailer.

It is accordingly an object of this invention to provide a novel method and apparatus to cover and uncover, and to secure, cargo loaded on a flatbed trailer.

These and many other objects and advantages of the present invention will be readily apparent to one skilled in the art to which the invention pertains from a review of claims, the appended drawings and the following detailed description of preferred embodiments.

### BRIEF DESCRIPTION OF THE DRAWINGS

FIG. 1 is a schematic view in elevation of one fixed embodiment of the present invention from the right side thereof.

FIG. 2 is a schematic view in elevation of the embodiment of FIG. 1 from the rear end thereof.

FIG. 3 is a schematic view in elevation of one trailer mounted embodiment of the present invention from the right side thereof.

FIG. 4 a schematic side view in elevation of the embodiment of FIG. 3 from the rear end thereof.

### DESCRIPTION OF PREFERRED EMBODIMENTS

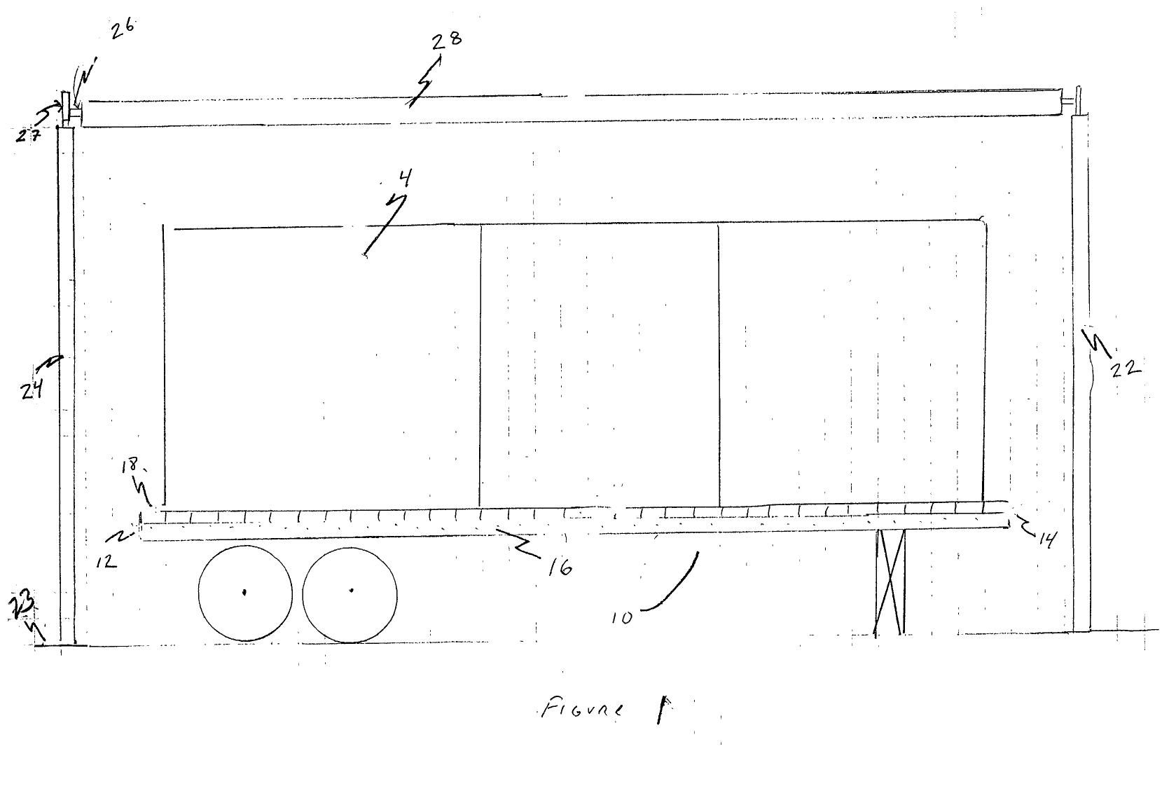

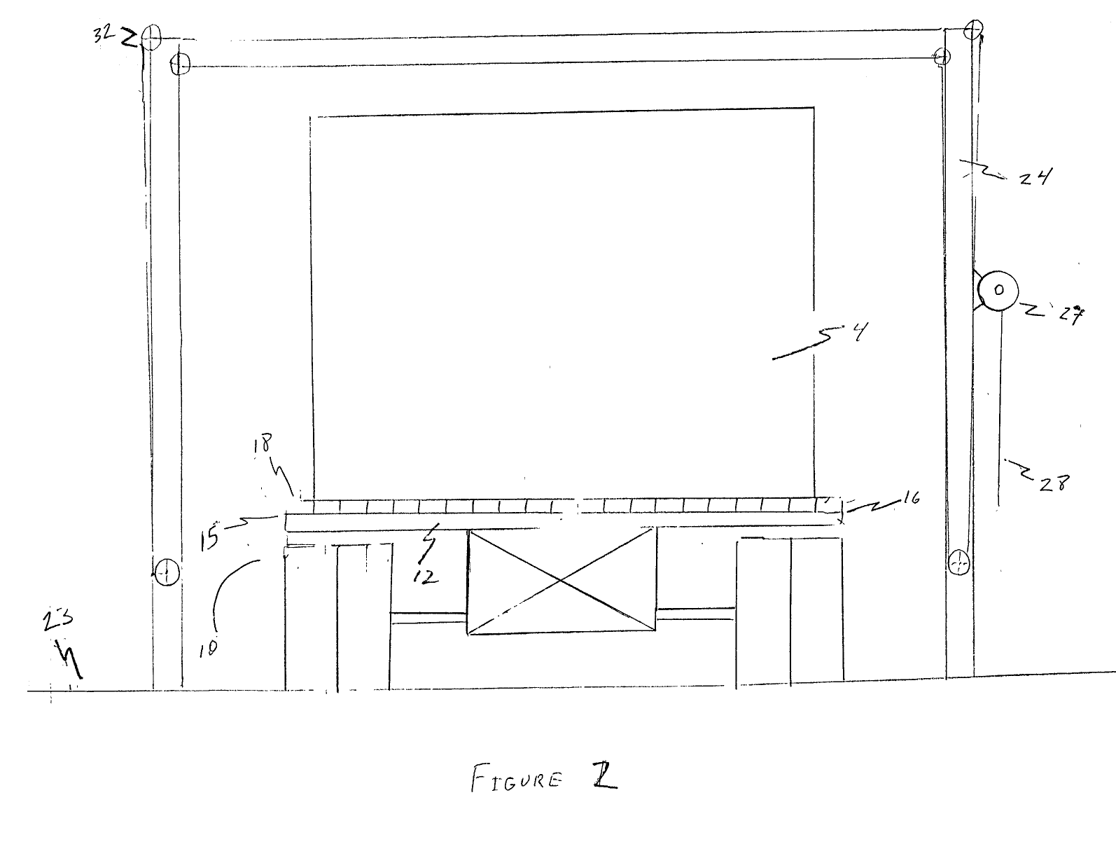

FIGS. 1 and 2 illustrate one embodiment of a fixed or stationary device 20 for the side-to-side covering and uncovering of cargo loaded on to a flatbed trailer at a terminal location to cover and uncover cargo loaded on flatbed trailers.

As shown in FIGS. 1 and 2, a conventional flatbed trailer 10 having a rear end 12, a front end 14, sides 15, 16 and a cargo carrying surface 18 may be loaded with cargo 4 to be covered. The trailer 10 may then be positioned by a tractor or other conventional means (not shown) on a generally level supporting base area 23 approximating the size of the trailer. Two supporting frames 22, 24 are conventionally installed at opposite ends of a base area 23. The supporting frames 22, 24 are generally an inverted U-shape and may be fabricated from any suitable material having the requisite strength and rigidity such as steel or aluminum.

As illustrated in FIG. 2, each of the supporting frames 22, 24 may be provided with an electric motor driven endless chain 31 or other suitable conventional means for selectively moving a tarp roller 27 up, over and down the exterior of the frames. Two motors may be used with the movement of the tarp roller 27 with respect to the two frames 22, 24 desirably automatically synchronized by any suitable conventional control circuit (not shown). Alternatively, conventional hydraulic means and control circuits may be used.

As illustrated in FIG. 1, an elongated bar 26 may be operatively connected to a tarp roller 27 at the ends thereof so that the elongated roller bar 26 may be selectively moved up, over and down the frames 22, 24 from a first position 15 alongside the flatbed trailer 10 to a second position 16 alongside the other side of the flatbed trailer 10. The tarp rollers 27 may conveniently be provided with electric motors to controllably rotate the elongated bar 26 independently of the position of the elongated bar 26 with respect to the frames 22, 24. If the tarp roller 27 of both of the frames 22, 24 is driven, the operation thereof may be synchronized by any suitable conventional means.

The control of the position of the tarp roller 27 with respect to the frames 22, 24 and the rotation of the elongated bar 26 may be accomplished from any convenient control station on the ground alongside the base area 23, e.g., mounted on one of the frames 22, 24. Desirably, the controls are located on a portable device operatively connected to the fixed control station by a control cable or a conventional wireless link. Manual movement means may also be provided for operation in the event of a loss of motive power.

In operation, a cover 28 of the appropriate size and material may be selectively attached along one side thereof to the elongated bar 26 by hooks and eyes, lines, snaps, or the like. The cover 28 may be rolled up on the elongated bar 26 leaving a relatively short length free for selective attachment in any conventional manner to the flatbed trailer 10 or to the cargo carried thereon. Alternatively, the free side of the cover 28 may be left dangling downwardly from the weight thereof. The elongated bar 26 may also include a roller or rollers (not shown) to which the cover 28 maybe attached.

As the tarp rollers 27 are moved up, over and down the far side of the frames 22, 24 the cover 28 may be unrolled to thereby drape the cargo 4. Once the cargo 4 has been draped, the cover 28 may be detached from the elongated bar 26 and secured to the flatbed trailer 10 or to the cargo in any conventional manner.

The tarp rollers 27 may then reposition the elongated bar 26 to repeat the process with another cover and another flatbed trailer. In this way, a number of flatbed trailers may be sequentially driven to the base area, covered and driven from the terminal.

The process as described above may also be reversed to uncover cargo, i.e. a flatbed with a covered cargo may be positioned on the base area 23 between the frames 22, 24 one side of the cover 28 attached to the elongated bar 26, and the cover rolled up as the tarp rollers 27 are driven up, over and down the frames 22, 24 to undrape the cargo 4. The uncovering of multiple flatbed trailers may also be accomplished by a similar reversal of the process.

It is to be understood that it may be convenient to store covers when not in use rolled up on elongated bar. In this way, the elongated bar with a cover rolled up thereof may be selectively attached to the tarp rollers to begin the covering process, and the elongated bar with a cover rolled up thereon in the uncovering of cargo detached from the tarp rollers for storage at the terminal.

It is to be understood that a plurality of flat straps or tie-downs may be selectively substituted for the cover and thereby positioned over the cargo, so that the present invention may be alternatively used to cover the cargo, secure the cargo, or both.

It is also to be understood that the base area and the frames may be manufactured as a unit and provided with wheels so that the entire unit may be selectively positioned with respect to a flatbed trailer. This may have particular utility at a terminal location where flatbed trailer are loaded in advance of the availability of a tractor.

A second embodiment of the present invention is described below as having utility on a flatbed trailer. The description will not be repeated here, but it is to be understood that this alternative embodiment may also be used in a terminal as described above. The embodiment of FIGS. 1 and 2 described above may also be mounted permanently or temporally on a conventional flatbed trailer.

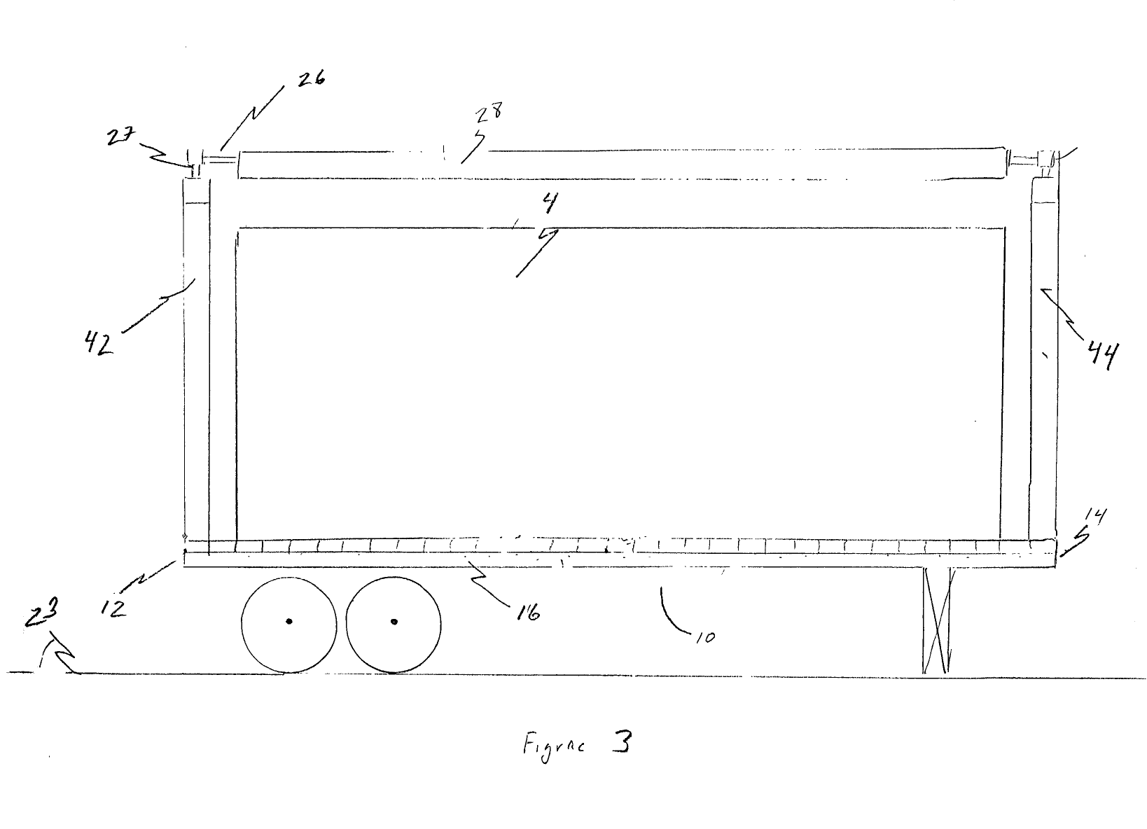

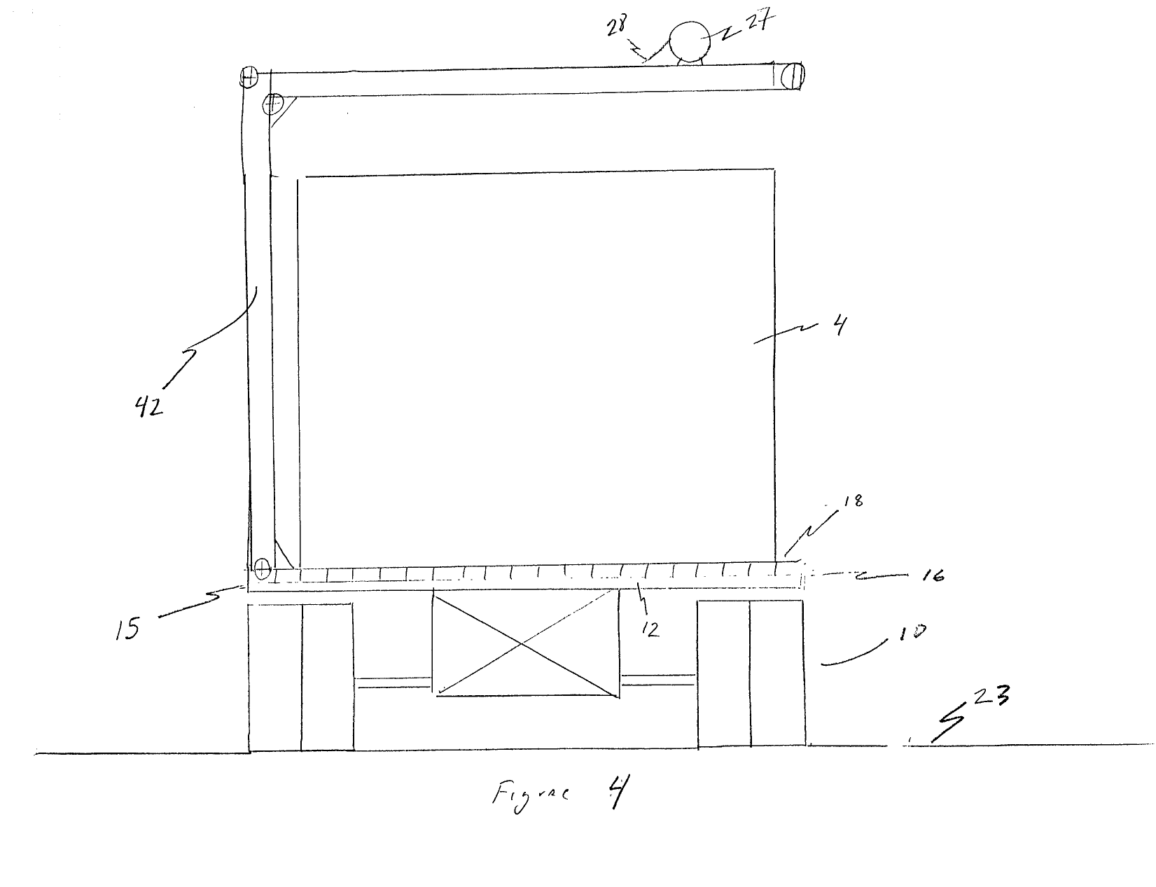

An alternative embodiment is illustrated in FIGS. 3 and 4 and may be preferable over the inverted U-shaped frames for use in flatbed trailers because of the reduced weight and the increased accessibility of the cargo carrying surface 18 for loading and unloading.

With reference to FIGS. 3 and 4, pair of supporting frames 42, 44 may be attached to the flatbed trailer 10. The frames 42, 44 are desirably generally L-shaped so that they extend upwardly from one side and over the cargo carrying surface 18 of a flatbed trailer 10. A relatively short downturn of the frame's horizontal portion may also be desirable as discussed below.

The mounting of the frames 42, 44 to the flatbed trailer 10 may be by any suitable conventional means. A horizontally extending brace may be provided in contact with the flatbed surface, making the frames generally C-shaped. The location of the frames 42, 44 at opposite ends of the flatbed trailer 10 allows cargo 4 to be loaded onto the cargo carrying surface 18 from the ends, sides or from above the flatbed trailer 10.

As described above in connection with FIGS. 1 and 2, each frame 42, 44 has a tarp roller 27 that is selectively positionable up and over the frame from a control station (not shown). As indicated above, it is desirable that the operations be controlled from the ground rather than on the trailer, and desirably from a position variable at the will of the operator so that the operator's view may be unimpeded during the various stages of the process. Control from a portable device is thus preferred.

The process of covering and uncovering cargo using the embodiment of FIGS. 3 and 4 differs in that gravity replaces the positive control of the edge of the cover 28 in contact with the elongated bar 26. For example, when the elongated bar 26 reaches the end of the frame 42, 44 in the covering process, there may still be a portion of the cover 28 rolled up thereon, and the position of the elongated bar 26 may be out of reach of the operator. However, the continued rotation of the elongated bar 26 to unroll the remainder of the cover 28 there from will cause the cover 28 to loop downwardly and to finally fall free under the force of gravity. In this embodiment, the uncovering process must begin from the side of the flatbed trailer 10 with the vertical portion of the frames 42, 44. As before, the elongated bar 26 may also include a roller or rollers (not shown) to which the cover 28 may be attached.

### ADVANTAGES AND SCOPE OF THE INVENTION

The trailer mounted embodiments of the present invention permit a single operator to easily and safely cover or uncover cargo before or during transit or after it has arrived at its destination. Yet it does not materially interfere with the loading or unloading of the cargo from either side or the rear of the trailer, or from above. Because the cargo may so readily be covered in transit, covering of the cargo may be postponed unless and until needed, saving time for the driver. In addition, the remote control of the process from varying positions on the ground has great utility.

The present invention also finds great utility at terminal locations, where a single fixed installation may be used to cover or uncover the cargo, or to secure the cargo, on each flatbed trailer leaving or arriving at the terminal location. Where it is desirable to load and cover cargo on flatbed trailers in advance of the actual departure, or even to temporarily store cargo on a flatbed trailer, the apparatus may itself be trailer mounted and sequentially positioned with respect to a plurality of parked flatbeds trailers.

Another significant advantage at a terminal location is that the covers themselves may be stored rolled up on an elongated bar, and the elongated bar and cover moved to the flatbed by mechanical means already available at the terminal, e.g., a fork lift. In this way, the necessity for manhandling of the covers may be avoided.

While preferred embodiment of the present invention have been described, it is the be understand that the embodiments described are illustrative only, and that the scope of the invention is to be defined solely by the appended claims when accorded a full range of equivalents, many variations and modifications naturally occurring to the skilled in the art from a perusal hereof.

What is claimed is:

1. An apparatus for covering and uncovering cargo loaded on a flatbed trailer supported on an elongated base area comprising:
a pair of spaced apart frames fixed to adjacent opposite ends of the elongated base area, each of said frames including at least one vertical component and a horizontal component extending laterally across the base area;
an elongated roller bar carried at opposite ends by said frames for selective movement from a first position alongside a flatbed trailer on one side of the trailer when supported on said base area upwardly and across the trailer to a second position on the other side of the trailer,
said elongated bar including means for the selective attachment of one side of a generally rectangular flexible cover so that movement of said elongated bar from said first to said second position will drape an attached cover across any cargo loaded on a trailer supported on said base.

2. The apparatus of claim 1 wherein said elongated bar includes one or more rollers to which a cover may be selectively attached so a cover may be selectively rolled thereon for storage and unrolled there from as said elongated bar moves from said first to said second position.

3. The apparatus of claim 1 wherein the position of said elongated bar relative to said frames is selectively controlled.

4. The apparatus of claim 3 wherein the position of the ends of said elongated bar relative to said frames is independently controlled.

5. The apparatus of claim 1 wherein the rotation of said elongated bar is selectively controlled.

6. The apparatus of claim 5 wherein the position of said elongated bar relative to said frames and the rotation of said elongated bar are independently controlled.

7. The apparatus of claim 1 wherein said frames each include a track with an endless chain; and
including an electric motor associated with at least one of said frames for driving said endless chain around said track.

8. The apparatus of claim 1 wherein said base area is a portion of a substantially larger generally horizontal surface.

9. The apparatus of claim 8 including a wheeled base positionable with respect to said base area; and
wherein said frames are carried by said wheeled base.

10. The apparatus of claim 1 including a wheeled base the upper surface of which defines said base area; and
wherein said frames are carried by said wheeled base.

11. The apparatus of claim 1 wherein each of said frames include a second vertical component and has an inverted generally U-shape;
wherein said second position is alongside the flatbed trailer.

12. A trailer mounted apparatus for covering and uncovering cargo loaded on the trailer comprising:
first and a second frames each having a generally vertical and a generally horizontal component, the free ends of said vertical components being adapted for support by a trailer adjacent opposite ends of the trailer along the same side thereof with the horizontal components extending laterally across the trailer on which supported;
an endless chain carried by each of said frames; and
an elongated bar carried at opposite ends by the endless chain of said frames for selective movement from a first position adjacent the free end of said vertical components to a second position adjacent the free ends of said horizontal components,
said elongated bar including means for the selective attachment of a generally rectangular flexible cover so that movement of said elongated bar from said first to said second position will position a cover attached thereto across any cargo loaded on the trailer.

13. The apparatus of claim 12 wherein said elongated bar includes one or more rollers to which a cover may be selectively attached so a cover may be selectively rolled thereon for storage and unrolled there from as said elongated bar moves from said first to said second position.

14. The apparatus of claim 13 wherein the position of said elongated bar relative to said frames and the rotation of said elongated bar about the longitudinal axis thereof is selectively controlled.

15. The apparatus of claim 14 wherein the position of said elongated bar relative to said frames and the rotation of said bar are independently controlled.

16. The apparatus of claim 12 wherein said frames each include a track with an endless chain; and
including an electric motor associated with at least one of said frames for driving said endless chain around said track.

17. The apparatus of claim 12 wherein each of said frames include a second vertical component and has an inverted generally U-shape;
wherein said second position is alongside the flatbed trailer.

18. In a flatbed trailer with a cover for selectively covering cargo carried on the flatbed trailer, the improvement comprising a roller for the cover carried at opposite ends by a pair of frames laterally extending across the flatbed trailer adjacent opposite ends thereof.

19. In an apparatus for selectively covering cargo carried on a trailer, a pair of parallel tracks extending laterally across an area suitable for supporting a cargo carrying trailer and an elongated roller supported at opposite ends by said tracks for controlled movement there along.

20. The apparatus of claim 19 wherein the movement of the ends of said roller along said tracks is synchronized;
wherein said roller is controllably rotated independently of the movement of said roller relative to said tracks.

21. The apparatus of claim 20 wherein the movement of the ends of said roller along said tracks and the rotation of wherein said roller is controllable from selective positions on the ground.

22. A method of covering cargo on a flatbed trailer comprising:
(a) providing spaced apart parallel frames laterally crossing an area suitable for supporting a cargo carrying flatbed trailer;
(b) positioning a cargo carrying flatbed trailer so that the frames cross the flatbed trailer at adjacent opposite ends thereof;
(c) attaching a flexible cover to an roller supported at opposite ends by the frames;
(d) moving said roller from a first position laterally of the flatbed trailer on one side thereof upwardly, across the flatbed trailer and downwardly to a second position laterally of the flatbed trailer on the other side thereof to thereby drape the cover over the cargo on the flatbed trailer; and
(e) securing the cover to at least one of the flatbed trailer and the cargo.

23. The method of claim 22 wherein the frames are generally an inverted U-shaped.

24. The method of claim 22 wherein the frames are generally I-shaped.

25. A method of covering cargo on a flatbed trailer comprising:
(a) mounting spaced apart frames adjacent opposite end of a flatbed trailer;
(b) attaching a flexible cover to an elongated roller supported at opposite ends by the frames;
(c) moving said elongated roller from a first position adjacent the flatbed trailer on one side thereof upwardly and across the flatbed trailer to a second position on the other side thereof to thereby drape the cover over the cargo on the flatbed trailer;
(d) securing the cover to at least one of the flatbed trailer and the cargo.

26. The method of claim 25 wherein the frames are generally an inverted U-shaped.

27. The method of claim 25 wherein the frames are generally I-shaped.

28. A method of covering cargo on a flatbed trailer comprising:
(a) mounting spaced apart, parallel, inverted generally U-shaped frames adjacent opposite end of a flatbed trailer spaced laterally there from;
(b) providing a roller supported at opposite ends by said frames at a first position approximately the height of the flatbed trailer with a flexible cover rolled up thereon;
(c) moving the roller from the first position laterally spaced from the flatbed trailer on one side thereof upwardly and across the flatbed trailer to a second position substantially vertically over the edge of the flatbed trailer;
(d) unrolling the cover sufficiently for the free end thereof to approximately the height of the flatbed trailer; and
(e) moving the roller across the flatbed trailer to a third position substantially vertically over the edge of the flatbed trailer on the other side thereof and unrolling the cover from the roller to thereby drape the cover over the cargo on the flatbed trailer.
